(19) United States
(12) Patent Application Publication
(10) Pub. No.: US 2026/0252240 A1
(43) Pub. Date: Aug. 27, 2026

(54) MONITORING THE HEALTH OF A DATA STORAGE DEVICE TO INCREASE RELIABILITY AND PERFORMANCE

(71) Applicant: Microchip Technology Incorporated, Chandler, AZ (US)

(72) Inventors: Nian Niles Yang, Mountain View, CA (US); Pitamber Shukla, San Jose, CA (US); Hichem Belhadj Mohamed, Loomis, CA (US)

(73) Assignee: Microchip Technology Incorporated, Chandler, AZ (US)

(21) Appl. No.: 19/221,134

(22) Filed: May 28, 2025

Related U.S. Application Data
(60) Provisional application No. 63/761,276, filed on Feb. 21, 2025.

(51) Int. Cl. G06F 3/06

(52) U.S. Cl. CPC G06F 3/0614; G06F 3/0653; G06F 3/0683

(57) ABSTRACT

A computer-implemented method, media, and systems for monitoring the health of a data storage device by: aggregating, or collecting, aggregate health data of a plurality of data storage devices and modifying, based on the aggregate health date, an aspect of memory management by one or both of: enacting an operational change on at least one of the plurality of data storage devices, or making a responsibility assignment modification for one or more operations among the plurality of data storage devices.

The current patent application claims the benefit under 35 U.S.C. § 119(e) of the priority date of U.S. Provisional Application Ser. No. 63/761,276 titled “MONITORING THE HEALTH OF A NAND FLASH DEVICE TO INCREASE RELIABILITY AND PERFORMANCE” and filed Feb. 21, 2025. The Provisional Application is hereby incorporated by reference, in its entirety, into the current patent application.

### TECHNICAL FIELD

Various examples of the present disclosure relate to systems, media, and methods for monitoring the health of a data storage device. More particularly, various examples relate to monitoring the health of NOT-AND (NAND) flash devices, such as solid-state drives (SSDs), to increase reliability and performance of the device.

### BACKGROUND

SSDs are an integral component of datacenter solutions (DCS) and artificial intelligence (AI). For example, DCS and AI infrastructure may include up to dozens, hundreds, or thousands of SSDs, wherein each SSD may include up to dozens, hundreds, or thousands of dies of NAND-based non-volatile memory media, e.g., for data storage purposes. As a result, the SSDs included in these DCS/AI systems may introduce between hundreds and millions of potential points of failure into the system, the effect(s) of which may range from partial to complete data loss across the system.

This background discussion is intended to provide information related to the present invention which is not necessarily prior art.

### SUMMARY OF THE INVENTION

According to various examples of the present disclosure, non-transitory computer-readable media are provided. The non-transitory computer-readable media may have instructions embodied thereon which, when executed by one or more processors coupled thereto, cause the one or more processors to: aggregate health data of a plurality of data storage devices; and modify, based on the aggregate health data, an aspect of memory management. The aspect(s) of memory management may be modified by one or both of enacting an operational change on at least one of the plurality of data storage devices, or making a responsibility assignment modification for one or more operations among the plurality of data storage devices.

According to various examples of the present disclosure, a system for monitoring the health of a data storage device may include: a computing device communicatively coupled to a plurality of data storage devices; one or more processors; and computer-readable media having instructions embodied thereon which, when executed by the one or more processors, causes the one or more processors to: aggregate health data of the plurality of data storage devices; and modify, based on the aggregate health data, an aspect of memory management by one or both of: enacting an operational change on at least one of the plurality of data storage devices, or making a responsibility assignment modification for one or more of the operations among the plurality of data storage devices.

This summary is not intended to identify essential features of the examples, and is not intended to be used to limit the scope of the claims. These and other aspects of the present examples are described below in greater detail.

### BRIEF DESCRIPTION OF THE DRAWINGS

FIG. 1 illustrates an example environmental view of a system for monitoring the health of data storage devices;

FIG. 2 illustrates an example health monitoring component that may be included in the system of FIG. 1;

FIG. 3 illustrates an example computing system configured to perform operations in accordance with the various examples of the present disclosure;

FIG. 4 illustrates an example data storage device of the system of FIG. 1;

FIG. 5 illustrates an example non-volatile memory (NVM) media of the system of FIG. 1;

FIG. 6 illustrates an example multi-plane block of an NVM of the system of FIG. 1; and

FIG. 7 illustrates an example method flow for monitoring the health of data storage devices in accordance with the system of FIG. 1.

### DETAILED DESCRIPTION

In the following detailed description, reference is made to the accompanying drawings, which form a part hereof and in which are shown, by way of illustration, specific examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure. Unless clearly understood or expressly identified otherwise, structures, materials, procedures, operations, and other aspects described in the context of one example may be incorporated into other examples.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

Terms of relative location and direction (e.g., above, below, left, right, upper, lower, lateral, horizontal, vertical, and the like) may be used to facilitate the present descriptions of examples with reference to the figures, but unless clearly understood or expressly identified otherwise, these terms are not meant to be limiting with regard to location, direction, or overall orientation, and may, for example, change as a result of a change in overall orientation.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, operations, features, functions, or the like.

It will be readily understood that the components of the examples as generally described herein and illustrated in the drawings could be arranged and designed in a wide variety of different configurations. Thus, the following description of various examples is not intended to limit the scope of the present disclosure but is merely representative of various examples.

In various examples of the present disclosure, a data storage device may include a data storage component and a controller. The data storage component of the data storage device may store data. The data storage device may be connected to a host system. In various examples, the data storage device may be connected to the host system by wired or wireless means. In various examples, the data storage device may be connected to more than one host system, such as in a multi-tenant environment, without limitation. Also or alternatively, the host system may be connected to more than one data storage device. The controller may be operable to manage storage and retrieval of data to and from the data storage component. The host system may send data to the data storage device for storage in the data storage component. The controller may process the data and issue commands to the data storage device and/or the data storage component for storing the data in the data storage component. The host system may send various requests to the data storage device(s), such as a read request. A request issued by the host to the data storage device may indicate data that is to be retrieved from the data storage component by the host.

For instance, a request to collect aggregate health data may indicate aggregate health data that is to be retrieved from or in relation to a particular data storage device(s) and sent back to the host system. The controller of each data storage device(s) from or for which aggregate health data was requested may: process the request to collect the aggregate health data, retrieve, and in some embodiments process, the requested aggregate health data from and/or for the data storage device, and transmit the retrieved and/or generated aggregate health data to the host system.

In various examples, the data storage device may be a NAND flash device, such as an SSD. In various other examples, the data storage device may be a server or other computing devices that includes one or more SSDs. The data storage component of the data storage device may include a plurality of NVM media (e.g., NAND-based memory media) for data storage. The data storage device may include a flash controller that is communicatively coupled to the data storage component, and the data storage component may include one or more additional, local controllers communicatively coupled thereto. The flash controller and/or one or more of the local controllers may be communicatively coupled to a health monitoring component. The health monitoring component may aggregate, or collect, aggregate health data for/from one or more of data storage devices. The health monitoring component may include circuitry that facilitates the aggregation/collection of aggregate health data. One or more health scores for any combination of the one or more data storage devices to which the health monitoring component is communicatively coupled may be generated based on the aggregated health data. Each of the health scores may correspond to a health status of the corresponding data storage device for which the health score was generated. Change(s) in, or modification(s) to the operation and/or management of the data storage device(s) may be enacted based on the health status and/or health score.

In various examples, the health monitoring component may be communicatively coupled to, included in, and/or executing on a host system. The host may be included in the data storage device, the host may be included in a computing device that includes the data storage component, the host and the data storage device may be disparate and/or remote from one another and/or encased in physically discontinuous housings, or otherwise without departing from the spirit of the present disclosure. In various examples, a health monitoring component of a host system managing operation of a plurality of data storage devices, such as an SSD or a server including a plurality of SSDs, may advantageously provide visibility into and knowledge of previously unknown SSD aggregate health data for the SSDs, enabling previously-unavailable, improved, and coordinated methods of managing such SSDs.

Various examples of the present disclosure relate to systems, media, and methods for monitoring the health of a data storage device, such as an SSD or other NAND flash device. The system may include a host communicatively coupled to one or more data storage devices, one or more processors, and a memory. The memory may have instructions embodied thereon which, when executed by the one or more processors, cause the processor(s) to: aggregate data corresponding to health score(s) of the data storage device(s); determine, based on the health score data, a health score for each of the data storage device(s); and implement, based on the determined health score(s), operational change(s) to the performance of the data storage device(s).

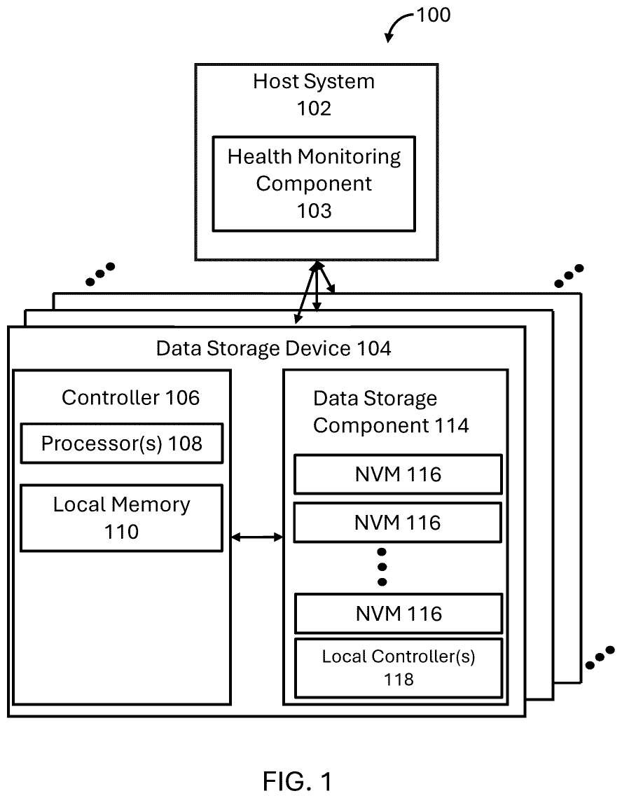

FIG. 1 illustrates an example system 100 including a host system 102 in communication with a plurality of data storage devices 104. In various examples, one or more such data storage devices may be differently constructed without departing from the spirit of the present disclosure. Generally, a data storage device is a device, or hardware component, that retains digital data. Data retention may be temporary (volatile) or permanent (non-volatile), depending on the type of data storage device. Examples of data storage devices may include, but are not limited to: HDDs, SSDs, universal serial bus (USB) drives, secure digital memory cards (SD cards), micro-SD cards, and the like. Data storage devices may be communicatively coupled to computing devices, and data storage devices may be housed/enclosed in computing devices (e.g., an SSD(s) included in a laptop, PC, or mobile device), or external to the computing devices (e.g., external HDDs/SSD, network attached storage (NAS), servers, data centers, etc.). According to the present disclosure, it may be preferable for a data storage device to be a non-volatile, NAND flash-based storage device, such as an SSD. In various examples, each of the data storage devices 104 may be a NAND flash-based data storage device, such as an SSD.

The host system 102 may request aggregate health data from any combination of the data storage device(s) 104 to which it is communicatively coupled. Such request(s) may be managed and/or issued, and responses thereto received, via the health monitoring component 103. In various examples, all or some operations of the health monitoring component 103 may be housed, executed, and/or performed within one or more of the data storage devices(s) 104 within the scope of the present disclosure.

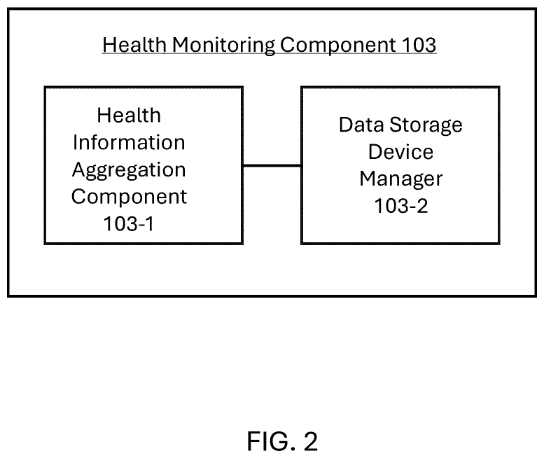

According to the present disclosure (e.g., as explained further in connection with the description of FIG. 2 below), the health monitoring component 103 may manage and/or provide instructions for altering or revising operations of the host system 102 and/or data storage device(s) 104, such as via operational changes on at least one of the data storage device(s) 104, and/or modifications to responsibility assignments for one or more operations (for example, read and/or write operations) among the plurality of data storage devices 104.

Accordingly, the health monitoring component 103 may include circuitry and/or media for: performing or otherwise enabling host read/write operations; aggregating, or collecting, aggregate health data from one or more of the data storage device(s) (e.g., each of the data storage devices 104) communicatively coupled thereto; monitoring and/or managing the health of the one or more of the data storage device(s) communicatively coupled thereto; and/or implementing change(s) to the operation and/or management of the one or more data storage device(s) communicatively coupled thereto.

The host system 102 and/or the health monitoring component 103 may use aggregate health data and/or health score(s) calculated therefrom to change the operation of the data storage device(s) 104, including those for which the aggregate health data was collected and/or those for which the health score(s) were calculated. In various examples, the host system 102 and/or the health monitoring component 103 may use a combination of aggregate health data and health score(s) (e.g., health score(s) included in the aggregate health data and/or calculated therefrom) to change the operation and/or management of other components, devices, and/or systems communicatively thereto that are not depicted in the example system 100.

As illustrated in FIG. 1 and discussed above, the host system 102 may include the health monitoring component 103. In various examples, the host system 102 and each of the data storage devices 104 coupled thereto may be disparate and/or remote from one another and/or encased in physically discontinuous housings. A non-limiting example is a data center in which a host server comprising the host system 102 is housed in a different server rack from flash-based SSDs comprising the data storage devices 104. For another example, the host system 102 may be a memory management unit (MMU) and/or an operating system (OS) executing on a server located on the back-end of a webservice that is, for instance, transferring data to/from one or more of the SSDs included in and/or coupled to a client device (e.g., the personal computer, laptop, mobile device, external storage device, etc. of an end-user) that is accessing the webservice. This may include a user uploading new data to and/or retrieving previously stored data from a cloud-based data storage service.

In various other examples, the host system 102 and the health monitoring component 103 may be included in, or local to, a computing device that includes each of the data storage device(s) 104. For example, the host system 102 may be an MMU included in and/or an OS executing on a personal computer, laptop, mobile device, external storage device, etc. that is overseeing the operation/management of various hard disk drives (HDDs) and/or SSDs included therein and/or coupled thereto.

In various other examples, the system 100 may include a host system 102 that is disparate relative to and/or remote from one or more data storage device(s) 104 and also included in or local to a computing device in which one or more other of the data storage device(s) 104 are included.

The data storage device 104 may include a controller 106. The controller 106 may include a processor 108 and a local memory 110. The data storage device 104 may also include a data storage component 114. The data storage component 114 may include a plurality of NVM media 116 and one or more local controller(s) 118. In various examples of the present disclosure, the data storage device 104 may, optionally, include additional health monitoring component(s), such as circuitry and/or media (not shown) discussed in more detail above and below in connection with the health monitoring component 103.

In various examples of the present disclosure, the NVM media 116 may comprise one or more data cell or memory types, including, without limitation, single level cell (SLC) memory cells configured to store one (1) bit of data, multi-level cell (MLC) memory cells configured to store two (2) bits of data, triple level cell (TLC) memory cells configured to store three (3) bits of data, and/or quad level cell (QLC) memory cells configured to store four (4) bits of data.

FIG. 2 illustrates an example of the health monitoring component 103 of FIG. 1 As illustrated, the health monitoring component 103 may include a health information aggregation component 103-1 and a data storage device manager 103-2.

The health information aggregation component 103-1 aggregates, or collects, health information for one or more data storage devices (e.g., the data storage device 104) communicatively coupled thereto. The aggregate health data collected by the health information aggregation component 103-1 may correspond to or comprise one or more of bit error rate (BER) data, number of program/erase (P/E) cycles data, cross-temperature data, and/or quality of service (QoS) time data for operation of the one or more data storage devices. In various examples, the aggregate health data may also include a plurality of health scores respectively corresponding to the plurality of data storage devices, or one or more blocks, virtual blocks, and/or addresses included therein. The health score(s) included in the aggregate health data may be calculated based on any combination of the aforementioned BER, number of P/E cycles, cross-temperature, and QoS time. All or some of the BER, the number of P/E cycles, the cross-temperature, QoS time data, and health scores may relate to: a particular data transmission or set of data transmissions (e.g., most recent data transmission(s) or an average for ten (10) most recent data transmissions); a period of time (e.g., an immediately preceding time period such as the past five (5) seconds, the past five (5) minutes, etc., up to and including the lifespan of the data storage device 104 for which the data is requested); and/or a particular location (e.g., a block, a virtual block, and/or an address) within the data storage device 104 for which the data is requested. Currently existing health scores may be used to determine health scores at a later point in time. Additional details on how a health score is determined are provided below.

Broadly, a BER of a data storage device, such as a NAND flash device, is a measurement of the number of bits that are incorrectly received by the data storage device compared to the total number of bits that were transmitted to the data storage device. This unitless performance metric is typically calculated in two ways—as an accumulated measurement or as a sequential measurement. An accumulated measurement will count the number of incorrect bits in a given data transmission/over a given period of time and calculate BER as a ratio/percentage of the total number of errors counted during the transmission(s)/time period over the total number of bits transmitted in the transmission(s)/during the period of time (e.g., transmission of five (5) incorrect bits in a transmission of 1 million bits would result in a BER of 0.000005). A sequential measurement of BER compares each received bit to the corresponding transmitted bit and counts errors as they occur in-real time, and in sequence. As a result, sequential BER measurement is capable of providing immediate feedback on the quality of the communication channel transmitting the data.

A P/E cycle of a data storage device, such as a NAND flash device, may refer to a single cycle of writing (or “programming”) data to a memory cell included in the NAND flash device followed by erasing the data from the cell. Generally, P/E cycles are a key metric for determining overall health and lifespan of a NAND flash device, as each cell included in the blocks of NAND flash comprising the NAND flash device degrades as the device is used (i.e., with each program and/or erase operation performed thereon). As the cells of the NAND flash device degrade over time, data transmission to/from those cells becomes unreliable, until eventually, when enough cells become sufficiently degraded, the NAND flash device dies.

Data storage devices, such as SSDs and other NAND flash devices, may be susceptible to “cross-temperature.” Effects of cross-temperature may occur when a read temperature of a NAND flash device is sufficiently different than a temperature of the NAND flash device when data was programmed. For instance, cross-temperature would occur if data were programmed to an SSD at one hundred degrees Celsius (100° C.) but is currently being read at ten degrees Celsius (10° C.). To mitigate cross-temperature, a controller (e.g., the controller 106), which may include and/or be communicatively coupled to a temperature sensor and/or thermometer included in and/or communicatively coupled to the NAND flash device, may determine differences between the temperatures of the NAND flash device at or in association with read and write operations. Each measured or determined temperature may be a general temperature of the NAND flash device or a temperature at a particular location within the NAND flash device (e.g., the temperature of a particular block or cell included in the device). Over time, repeated instances of significant cross-temperatures or other significant temperature fluctuations and/or extreme temperatures in a NAND flash device can decrease reliability of operations being performed by, and can even shorten the lifespan of, the device.

A QoS time of a data storage device, such as a NAND flash device, broadly refers to the time it takes for that device to complete a specified or pre-determined number of data requests, often expressed as a ratio or percentage per time interval. For example, a QoS time of 99.9% at two (2) milliseconds (ms) would indicate that 99.9% of operations (e.g., programs and/or reads) performed on/by the NAND flash device are completed within 2 ms. Generally, QoS time is an indicator of drive reliability. Declining QoS times, which may be experienced by users as “lag” when performing ordinary operations such as accessing and/or transferring data, may indicate increasing instability in and/or decreasing reliability of the affected NAND flash device. A decrease in the percentage of operations that are completed in a given time interval and/or an increase in the time it takes to complete a pre-defined, or set, number of operations may be indicative of a declining QoS time. For instance, a QoS time of 98.0% at 2 ms or 99.9% at 5 ms could each be indicative of a declining QoS time when compared to the example QoS time of 99.9% at 2 ms presented earlier in this paragraph.

Returning generally to description of FIG. 1, the controller 106 may use logical block addresses (LBAs) and physical block addresses (PBAs) to facilitate access for data storage in and retrieval from the NVM media 116. LBAs are an abstraction to allow the operating system to interact with the NVM media 116, and PBAs represent the actual hardware locations within the NVM media 116. To facilitate interacting with the NVM media 116, the controller 106 may create an entry or record that assigns an LBA to a PBA. To keep track of all such LBA-to-PBA assignments, the controller 106 may use a logical-to-physical (L2P) mapping table. The L2P table may be uploaded to the local memory 110 so that it can be more quickly accessed and updated by the controller 106. In various examples, the local memory 110 may include a synchronous dynamic random access memory (SDRAM), without limitation.

In various examples of the present disclosure, a request for health data may be received from the health monitoring component 103 of, e.g., the host system 102, by way of a peripheral component interconnect express (PCIe) interface that connects the data storage device 104 to servers or CPUs comprising the host system 102. PCIe is a standardized interface for motherboard components. When a request for aggregate health data is received from the host system 102, the controller 106 may reference the L2P mapping table to determine the PBA within the NVM media 116 corresponding to a desired LBA. Once the PBA is determined, the controller 106 accesses the requested aggregate health data (e.g., via the appropriate NVM media 116) and/or from local memory 110. In various examples, the controller 106 may perform one or more operations responsive to the request for aggregate health data, such as performing a temperature measurement, to acquire or generate the requested data.

Access to the NVM media 116 may be via a flash physical (PHY) interface. The controller 106 may employ an error correction code (ECC) operation during encoding and decoding requested aggregate health data to detect and correct errors and enhance data integrity. Additionally, the data storage component 114 may support a direct memory access (DMA) operation. Generally, DMA enables data to be written from the host system 102 directly to the NVM media 116 and read from the NVM media 116 directly to the host system 102.

In accordance with various examples of the present disclosure, DMA may enable the host system 102 to retrieve aggregate health data responsive to one or more of: (i) completion of routine maintenance performed by the data storage device 104, or (ii) completion of routine health monitoring performed by the data storage device 104. Wear leveling, error correction, garbage collection, and other dedicated software utilities which may be included on the data storage device (e.g., embodied on the local memory 110 of the controller 106 included in the data storage device 104) are examples of the aforementioned routine maintenance/health monitoring. The host system 102 may issue commands to the controller 106 or the local controller(s) 118 using the host command layer, or non-volatile memory express management interface (NVMe-MI), to retrieve corresponding aggregate health data.

In various examples, the health monitoring component 103 may monitor the aggregate health data of a data storage device such as the data storage device 104 of FIG. 1, which may be a NAND flash device. The aggregate health data may be indicative of performance, reliability, and/or remaining useful lifespan of the data storage device 104. The aggregate health data may be aggregated in real-time during operation of the data storage device(s) included in the system (e.g., the system 100 of FIG. 1).

The data storage device manager 103-2 may use the aggregate health data to monitor the health status of the corresponding data storage devices. The data storage device manager 103-2 may modify, based on the aggregated health data, one or more aspects of memory management by one or both of: enacting an operational change on at least one of the plurality of data storage devices, or by making a responsibility assignment modification for one or more operations among the plurality of data storage devices. The modification(s) to the aspect(s) of memory management may be determined by a model taking the aggregate health data as input. The model may be configured to determine the modification(s) at least in part based on learned patterns of optimized performance of the plurality of data storage devices. In addition, the model may be periodically or intermittently retrained by the host system 102 or another computing device to correlate or embody such patterns of optimized performance, using aggregate health data as input.

As mentioned above, the aggregate health data may include multiple types of data corresponding to the overall health (e.g., reliability, performance, longevity, etc.) of a corresponding data storage device, such as a BER, a number of P/E cycles, a cross-temperature, a QoS time, and one or more health scores. In various examples, a health score may be generated for a data storage device, based on the aggregate health data collected from that device. The health score, and/or a health status corresponding thereto, may specifically relate to various components of the data storage device, such as one or more blocks, virtual blocks, and/or addresses included therein. Each of the plurality of health scores may be determined via a mathematical equation. In an example, a solution of the equation may be directly proportional to a sum of a first term, a second term, a third term, and a fourth term. The first term may comprise a product of a first coefficient (“a”) and a BER of the corresponding data storage device(s) (“BER”). The second term may comprise a product of a second coefficient (“b”) and a number of P/E cycles experienced by the relevant component(s) of the data storage device(s) (“P/E”). The third term may comprise a product of a third coefficient (“c”) and a cross-temperature experienced by the relevant component(s) of the data storage device (“Xtemp”). The fourth term may comprise a product of a fourth coefficient (“d”) and a QoS time for the relevant component(s) of the data storage device (“QoS”). Each of the first, second, third, and fourth coefficients may be pre-defined or determined dynamically during the operation of the plurality of data storage devices. For example, one or more of the coefficients may be stored in a look-up table (LUT), and/or one or more of the coefficients may be calculated or adjusted, e.g., based on an equation which may be pre-defined (e.g., stored in the LUT) or determined dynamically (e.g., based on the operation conditions of the system in which the one or more data storage devices are included).

The health score(s) may correspond, respectively, to the plurality of data storage devices (or blocks, virtual blocks, and/or physical or virtual addresses included therein). In various examples of the present disclosure, the mathematical “health score equation” may be represented as:

$$Health score = a * BER + b * PE + c * Xtemp + d * QoS$$

In various examples, one or more previously calculated health score may be used to determine one or more health score calculated at a future point in time.

The determination to modify an aspect of memory management may be based on determining adequacy of at least one of the plurality of health scores. For example, if a calculated health score is above a pre-determined threshold (e.g., 80 out of 100, or above), no action, external intervention, or modification by the host system 102 may be required. However, if the calculated health score is below a pre-determined threshold (e.g., 60 out of 100, or below) a modification to memory management may be required.

In various examples, modifications to memory management may be made based on ranking aggregate health data and health scores across multiple data storage device(s) 104 under management by the host system 102, or multiple components thereof. For example, though performance of all such data storage device(s) 104 may be satisfactory, suggestions or recommendations for improving performance of the entire system 100 may still be made and implemented.

In still other examples, aggregate health data (e.g., one or more of a BER, a number of P/E cycles, a cross-temperature, a QoS time, or a health score of a corresponding data storage device) and/or one or more of health scores calculated therefrom may be related to patterns of optimal performance without thresholds or rankings. For example, inconsistent performance within an otherwise satisfactory data storage device 104 may lead the model to optimize performance thereof by temporarily shifting responsibility for read/write operations away from the device to permit completion of garbage collection. For another example, performance may be reduced to preserve the resources and capabilities of a high-performing data storage device 104.

Returning to examples relying on unsatisfactory performance, if a determined health score is sufficiently low, the host system 102 may produce a notification informing a user and/or administrator that the corresponding data storage device 104 or relevant component thereof requires attention and/or should be the subject of a modification to memory management. The notification may, in various examples, include one or more automatically-generated (e.g., via the model discussed in more detail above) suggested actions or modifications which may be implemented in view of the low health score. As non-limiting examples, it may be suggested that the device(s) with sufficiently low health scores: stop having data written thereto and/or read therefrom, be backed-up and/or replaced, etc. In various examples, the host system 102 may be configured to automatically implement modifications to memory management.

Other modifications which may be suggested or automatically implemented based on aggregate health data and/or health scores generated therefrom include changes to operational rates of one or more data storage device(s) 104 managed by the host system 102. For example, the host system 102 may, based on one or more such health score(s) and/or the aggregate health data, generate a notification including a suggestion that data be read from or written to one or more affected data storage device(s) at an increased or decreased rate of speed. Reading data from or writing data to a data storage device at an increased rate may be referred to as “tuning up” speed. Reading data from or writing data to a data storage device at a decreased rate may be referred to as “tuning down” speed.

Still other modifications which may be suggested or automatically implemented based on aggregate health data and/or health scores generated therefrom include modifications to responsibility assignments. For example, the modification(s) may account for a low health score of affected data storage device(s), and may shift responsibility for read and/or write operations away from the affected data storage device (or a component thereof) to another component or data storage device (e.g., such that certain data may be read from an SSD 2 rather than an SSD 3, or be written to an SSD 1 rather than an SSD 4). Further, program and/or read operations being and/or scheduled to be performed on one or more of the data storage device(s) may be prioritized, de-prioritized, or halted all together based on the aggregate health data and/or health scores (e.g., already determined health scores included in the aggregate health data and/or health scores calculated therefrom).

Yet still other modifications or commands which may be suggested and/or automatically implemented by the data storage device manager 103-2 based on aggregate health data and/or health scores include instructions to one or more data device system(s) 104 to perform routine maintenance and/or health monitoring. Such maintenance and/or monitoring may include wear leveling, error correction, garbage collection, etc.

As noted above, the suggestions or automatically-implemented modifications discussed above may cause operation of the data storage device(s) to improve or otherwise more closely approximate patterns of optimized performance learned by the system model.

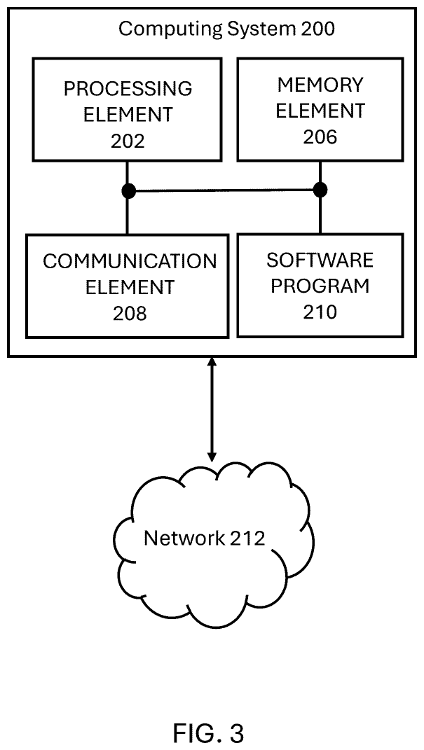

FIG. 3 illustrates a computing system 200 connected to a communication network 212. The computing system 200 may include at least one processing element 202, at least one memory element 206, a communication element 208, and a software program 210. In various examples, the computing system 200 may be a host system (e.g., the host system 102 of FIG. 1) and/or a data storage device (e.g., the data storage device(s) 104 of FIG. 1), without limitation.

The software program 210 may be configured with instructions for performing and/or enabling performance of at least some of the steps set forth herein. In an embodiment, the software program 210 comprises instructions stored on computer-readable media of memory element 206. In various examples, the software program 210 may include instructions for performing operations of the health monitoring component 103 discussed with reference to FIG. 1, or for performing operations of the controller 106 of FIG. 1.

The communication network 212 generally allows communication between the computing system 200 and another computing device, such as between a remote host system (e.g., the host system 102), a local host system, and/or a data storage device (e.g., the data storage device 104 of FIG. 1), without limitation.

The communication network 212 may include the Internet, cellular communication networks, local area networks, metro area networks, wide area networks, cloud networks, plain old telephone service (POTS) networks, and the like, or combinations thereof. The communication network 212 may be wired, wireless, or combinations thereof and may include components such as modems, gateways, switches, routers, hubs, access points, repeaters, towers, and the like. The computing system 200 may, for example, connect to the communication network 212 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The communication element 208 generally allows communication between the computing system 200 and the communication network 212. The communication element 208 may include transmitter(s), receiver(s), and/or transceiver(s). The communication element 208 may also/alternatively include signal or data transmitting and receiving circuits, such as antennas, amplifiers, filters, mixers, oscillators, digital signal processors (DSPs), and the like. The communication element 208 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard, such as WiFi, IEEE 802.16 standard, such as WiMAX, Bluetooth™, or combinations thereof. In addition, the communication element 208 may utilize communication standards such as ANT, ANT+, Bluetooth™ low energy (BLE), the industrial, scientific, and medical (ISM) band at 2.4 gigahertz (GHz), or the like. Alternatively, or in addition, the communication element 208 may establish communication through connectors or couplers that receive metal conductor wires or cables, like Cat 6 or coax cable, which are compatible with networking technologies such as ethernet. In certain embodiments, the communication element 208 may also couple with optical fiber cables. The communication element 208 may respectively be in communication with the processing element 202 and/or the memory element 206.

The memory element 206 may include electronic hardware data storage components such as read-only memory (ROM), programmable ROM, erasable programmable ROM, random-access memory (RAM) such as static RAM (SRAM) or dynamic RAM (DRAM), SSDs, cache memory, hard disks, floppy disks, optical disks, flash memory, thumb drives, USB drives, or the like, or combinations thereof. In some embodiments, the memory element 206 may be embedded in, or packaged in the same package as, the processing element 202. The memory element 206 may include, or may constitute, a “computer-readable medium.” The memory element 206 may store the instructions, code, code segments, software, firmware, programs, applications, apps, services, daemons, or the like that are executed by the processing element 202. In an embodiment, the memory element 206 store the software applications/program 210. The memory element 206 may also store settings, data, documents, sound files, photographs, movies, images, databases, and the like. In various examples, the memory element 206 may include a first memory component (e.g., the local memory 110 of FIG. 1) and one or more SSDs (e.g., the data storage device 104 of FIG. 1).

The processing element 202 may include electronic hardware components such as processors. The processing element 202 may include digital processing unit(s). The processing element 202 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 202 may generally execute, process, or run instructions, code, code segments, software, firmware, programs, applications, apps, processes, services, daemons, or the like. For instance, the processing element 202 may respectively execute the software applications/program 210. The processing element 202 may also include hardware components such as finite-state machines, sequential and combinational logic, and other electronic circuits that can perform the functions necessary for the operation of the current disclosure. The processing element 202 may be in communication with the other electronic components through serial or parallel links that include universal busses, address busses, data busses, control lines, and the like.

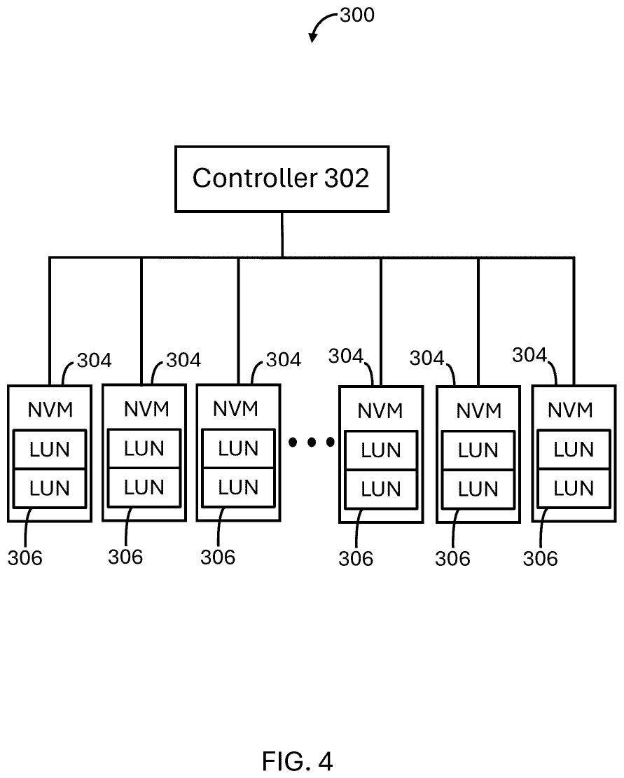

FIG. 4 illustrates an example data storage system 300 including a controller 302 and a plurality of NVM media 304. In various examples, the data storage system 300 may correspond to the data storage device 104 of FIG. 1, the controller 302 may correspond to the controller 106 of FIG. 1, and the NVM media 304 may correspond to the NVM media 116 of FIG. 1, without limitation. In various examples, the NVM media 304 may each include two LUNs 306. It would be appreciated by one of ordinary skill in the art that each NVM 304 may include more than two LUNs, without limitation. Each LUN 306 may correspond to a respective die of the NVM media 304. In various examples, the controller 302 may write incoming data to more than one NVM media 304 in parallel. The NVM media 304 may write incoming data to more than one LUN 306 in parallel. Each LUN 306 may include a set of multi-plane blocks.

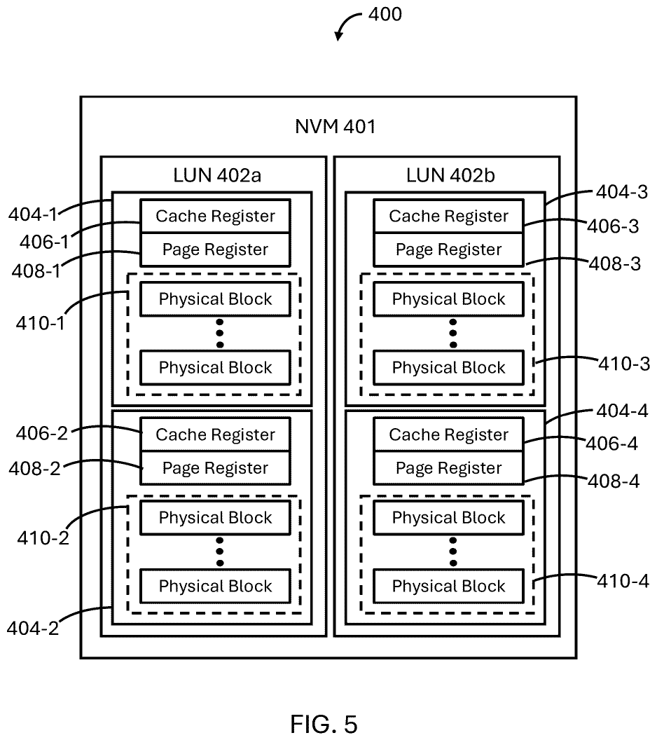

FIG. 5 illustrates an example NVM media 400. The NVM 400 may correspond to the NVM media 116 of FIG. 1 and/or the NVM media 304 of FIG. 3, without limitation. The NVM media 400 may include a LUN 402a and a LUN 402b. The LUN 402a may include a plane 404-1 and a plane 404-2. The plane 404-1 may include a cache register 406-1, a page register 408-1, and physical blocks 410-1. The plane 404-2 may include a cache register 406-2, a page register 408-2, and physical blocks 410-2. The LUN 402b may include a plane 404-3 and a plane 404-4. The plane 404-3 may include a cache register 406-3, a page register 408-3, and physical blocks 410-3. The plane 404-4 may include a cache register 406-4, a page register 408-4, and physical blocks 410-4. It would be appreciated by one of ordinary skill in the art that the NVM media 400 may include more than two (2) die and each die may include more than two (2) planes. In various examples, the NVM media 400 may include two (2), four (4), eight (8), sixteen (16), twenty four (24), thirty two (32), or more die, without limitation. Each die may include, for example, four (4), six (6), eight (8), or more planes, without limitation.

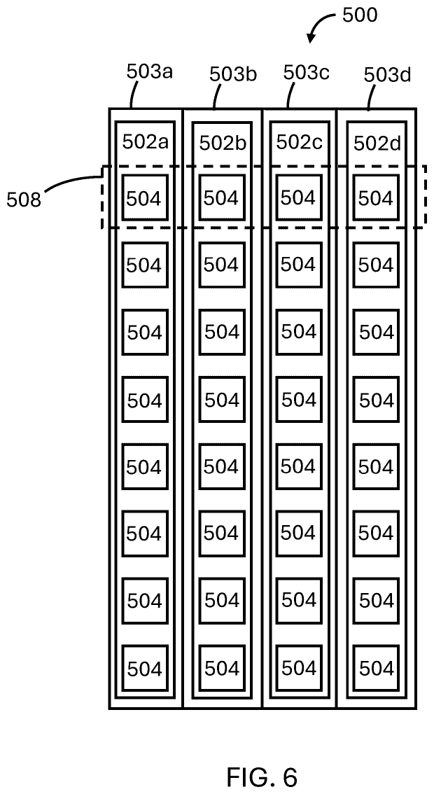

Each multi-plane block may include a multi-plane WL (e.g., the multi-plane WL 508 of FIG. 6). Accordingly, each set of multi-plane blocks may include a corresponding set of multi-plane WLs. For example, a first multi-plane WL may include a WL of one of the physical blocks 410-1 and a WL of one of the physical blocks 410-2. A second multi-plane WL may include a WL from one of the physical blocks 410-3 and a WL of one of the physical blocks 410-4. In an example, a multi-plane WL may include one (1) WL from each plane 404-1, 404-2, 404-3, 404-4. A multi-plane block may include one (1) physical block 410-1 from the plane 404-1, one (1) physical block 410-2 from the plane 404-2, one (1) physical block 410-3 from the plane 404-3, and one (1) physical block 410-4 from the plane 404-4. The WLs or physical blocks that make up a multi-plane WL or multi-page block may or may not be in a same location of each plane of a corresponding one of the LUNs 402a, 402b.

FIG. 6 illustrates a multi-plane block 500 of an NVM (e.g., the NVM media 116 of FIG. 1). The multi-plane block may include physical blocks 502a, 502b, 502c, 502d. The physical blocks 502a, 502b, 502c, 502d may be included in a set of planes 503a, 503b, 503c, 503d. Each physical block 502a, 502b, 502c, 502d may include a set of pages 504. A multi-plane WL 508 may be formed to include a page 504 of each physical block 502a, 502b, 502c, 502d.

In accordance with the present disclosure, the above-described block(s) and multi-plane block(s) may be virtual block(s) (VBs) and/or virtual multi-plane block(s). Broadly, a virtual block is a logical organization of physical blocks. VBs may include one or more blocks from each plane of each LUN. A VB may sometimes include the same block from each plane of each LUN (e.g., the first block of planes 1, 2, 3, etc.). Other times, a VB may include different blocks from different LUNs (e.g., the fourth block of plane 1, the first block of plane 2, the sixth block of plane 3, etc.). A total number of blocks in a VB may equal the total number of planes in the corresponding data storage device (e.g., NAND flash device and/or SSD). The number of VBs in a data storage device is generally equal to the number of physical blocks in one plane.

VBs include virtual wordlines (or virtual WLs, or VWLs). Each VWL may span one page from each plane of each LUN. The number of VWLs in a VB may equal the number of WLs in one physical block. A VWL may include a number of WLs equal to the number of physical blocks in the VB.

A BER for any combination of the pages 504 included in multi-plane block 500 comprising a virtual block may be calculated, e.g., by using either an accumulated or sequential measurement of the data being transmitted thereto. The health monitoring component 103 may utilize this BER to calculate a health score for the data storage device, such as the data storage device 104, according to the health score equation discussed above.

Similarly, a number of P/E cycles experienced by a data storage device, such as the data storage device 104, may be monitored and/or recorded (e.g., via firmware executing on/a counter within the controller 106). This number of P/E cycles may be utilized by the health monitoring component 103 to calculate a health score for the data storage device, according to the health score equation discussed above.

Similarly, a temperature measurement component (not shown in FIG. 1) included in the data storage device (e.g., data storage device 104) may measure the temperature of the device during read and write operations over a period of time and/or at particular locations (e.g., the various physical blocks 502a, 502b, 502c, 502d) within the device to calculate cross-temperature that may be affecting the device, as discussed in more detail above. The host system 102 may use this cross-temperature to calculate a health score for the data storage device, according to the health score equation discussed above.

Similarly, a QoS time for a data storage device, such as the data storage device 104, may be monitored and/or recorded (e.g., via firmware executing on/a counter within the controller 106). This QoS time may be utilized by the health monitoring component 103 to calculate a health score for the data storage device, according to the health score equation discussed above.

In various examples of the present disclosure, previously generated, or calculated, health scores may be used in determining one or more health scores at a future point(s) in time. A health score determined using an already existing health score may or may not be generated in accordance with the “health score equation” described above.

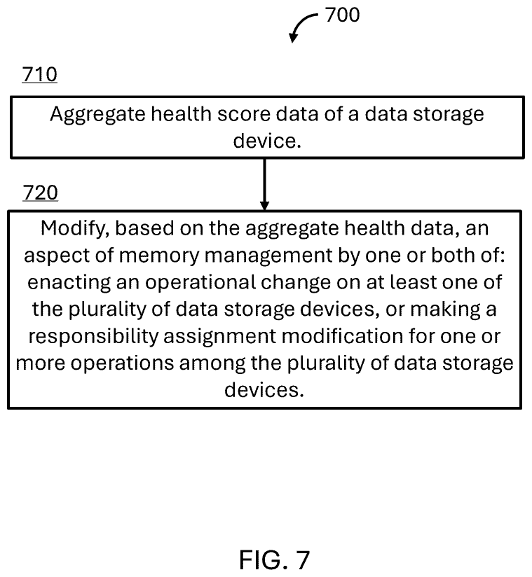

FIG. 7 illustrates an example method 700 for monitoring the health of a data storage device, such as an SSD or other NAND flash device, and modifying an aspect of memory management based on results of the monitoring. The steps may be performed in the order shown in FIG. 7, or they may be performed in a different order. Further, some steps may be performed concurrently as opposed to sequentially, and some steps may be optional.

The method 700 may be performed by a host system (e.g., the host system 102 of FIG. 1) entirely, or a combination of the host system and a controller (e.g., the controller 106 and/or controller(s) 118 of FIG. 1) of a data storage device (e.g., the data storage device 104 of FIG. 1). For example, a request(s) for aggregate health data may optionally issue from the host system 102 to the data storage device 104, aggregate health data may be provided by the storage device 104 to the host system 102, the host system 102 may calculate health scores and/or determine one or more modifications to aspects of memory system management, and the host system 102 and/or the storage device(s) 104 may implement such modification(s). However, aspects of the method 700 attributed in examples to one of the host system 102 or data storage device 104 may instead be performed by the other, or by other computing devices within the scope of the present disclosure.

The method 700 may operate with reference to the health and operation of a block, a virtual block, and/or an address of each of one or more data storage device(s) and/or system(s) (e.g., the data storage device 104) described in more detail above in connection with FIGS. 1-6. However, a person having ordinary skill will appreciate that other components and/or components at other levels of logical abstraction may be monitored and optimized without departing from the spirit of the present disclosure.

One or more computer-readable medium(s) may also be provided. The computer-readable medium(s) may include one or more executable programs stored thereon, such as firmware programs, wherein the program(s) instruct one or more processing elements to perform all or certain of the steps or operations outlined herein. The program(s) stored on the computer-readable medium(s) may instruct the processing element(s) to perform additional, fewer, or alternative actions, including those discussed elsewhere herein.

At operation 710, aggregate health data of one or more data storage devices (e.g., the data storage device 104 of FIG. 1) is aggregated. In various examples, the data storage device(s) may comprise NAND flash-based data storage devices, such as SSDs, or array(s) of NAND flash devices, such as in a server. A controller of each data storage device may manage storage and retrieval of data to and from one or more data storage component(s) (e.g., the data storage component 114 of FIG. 1) of each data storage device. The controller may receive requests for aggregate health data from a host system (e.g., the host system 102 of FIG. 1). Upon receiving a request for aggregate health data, the controller may facilitate transmitting the requested data to the host system. Also or alternatively, the controller may periodically, continuously, and/or when triggered by one or more other events, transmit such aggregate health data to the host system.

More particularly, the aggregate health data may be aggregated by a health information aggregation component, e.g., the health information aggregation component 103-1 included in the health monitoring component 103 of FIG. 1. The health monitoring component may be included in one or more host systems (e.g., the host system 102 of FIG. 1) communicatively coupled to the data storage device(s). The aggregate health data may be aggregated responsive to a command or series of commands from the health monitoring component requesting retrieval of the aggregate health data from and/or relating to said data storage devices. As noted above, however, the data storage devices may simply be configured to transmit such data to the health monitoring component at various times.

Also as described above, the aggregate health data may comprise or be used to generate one or more of the following with reference to one or more of the plurality of data storage devices or component(s) thereof: a BER, a number of P/E cycles, a cross-temperature, a QoS time, or a health score.

At operation 720, an aspect of memory management of at least one of the plurality of data storage devices may be modified based on the aggregate health data. According to the present disclosure, the aggregate health data may include or be used to generate a plurality of health scores corresponding to the respective data storage device(s) or component(s) thereof. Each health score may be calculated using the “health score equation” described above.

The aspect(s) of memory management may be modified via one or both of: enacting an operational change on at least one of the plurality of data storage devices, or making a responsibility assignment modification for one or more operations among the plurality of data storage devices. The modification(s) to memory management may be based on the health score and/or a health status corresponding thereto. For instance, certain modifications may be enacted if the health score is above a pre-determined threshold while other modifications may be made if the health score is below a pre-determined threshold. The modifications may be enacted by a command or series of commands issued by the health monitoring component and/or the host system in which the health monitoring component is included to the corresponding data storage device(s).

Examples of operational changes that may be modified may include, but are not limited to performing one or more of the following actions/operations on the data storage device(s): tuning up or tuning down the rate of data transfer thereto/therefrom; prioritizing/de-prioritizing/halting read or write operations currently being performed or that are scheduled to be performed; performing/executing one or more of wear leveling, error correction, garage collection, or other software utilities/firmware dedicated to the maintenance/health monitoring of the data storage device(s); establishing conditions for determining whether a block(s), virtual block(s), or address(es) included in the data storage device(s) for which a health score(s) was calculated is good or bad; or combinations thereof. In various examples, operational changes may lead to or be associated with (re-)training a model for determining optimal performance of the corresponding data storage device(s), e.g., based on the conditions for determining good/bad blocks. Additional details on the above-mentioned operational changes can be found in preceding portions of the disclosure.

Examples of responsibility assignments that may be modified may include, but are not limited to: reading from or writing to a different block(s), virtual block(s), and/or address(es) of one or more of the data storage device(s) included in the system (e.g., the system 100 of FIG. 1); changing the timing of command transmissions (e.g., read, write and/or deallocate commands) and/or of associated operations to one or more of the data storage device(s); or combinations thereof. Additional details on the above-mentioned responsibility assignments can be found in the specification above.

Modifications to memory management may be enacted or targeted at the block, virtual block, and/or address level.

In various examples, the host system 102 and/or the health monitoring component 103 included therein may use the aggregated health data (e.g., calculated health score(s)) to implement change(s) to the operation (e.g., optimize performance) of other components, devices, and/or systems communicatively thereto that are not depicted in the example system 100.

Additional details for each of the method steps mentioned above can be found in the description of FIG. 1-6.

Through hardware, software, firmware, or various combinations thereof, any of the processing elements (e.g., of the controller 106 and/or local controller(s) of FIG. 1, the host system 102, the processing element 202 of FIG. 3, and/or the controller 302 of FIG. 4) may—alone or in combination with other processing elements—be configured to perform the operations of embodiments of the present disclosure. The embodiments described herein in connection with the attached drawing figures are intended to describe aspects of the disclosure in sufficient detail to enable those skilled in the art to practice the disclosure. Other embodiments can be utilized and changes can be made without departing from the scope of the present disclosure. The system may include additional, less, or alternate functionality and/or device(s), including those discussed elsewhere herein. The above and below detailed description is, therefore, not to be taken in a limiting sense. The scope of the present disclosure is defined only by the appended claims, along with the full scope of equivalents to which such claims are entitled, unless otherwise expressly stated and/or readily apparent to those skilled in the art from the description.

Additional processing may be performed as desired.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventors.

### Feature Combinations

According to various examples of the present disclosure, non-volatile computer-readable media having instructions embodied thereon which, when executed by one or more processors, cause the one or more processors to: aggregate health date of a plurality of data storage devices; and modify, based on the aggregate health data, an aspect of memory management. The aspect(s) of memory management may be modified via one or both of: enacting an operational change on at least one of the plurality of data storage devices, or making a responsibility assignment modification for one or more operations among the plurality of data storage devices.

In combination with any of the previous examples, aggregate health data may be aggregated in real-time during the operation of the plurality of data storage devices.

In combination with any of the previous examples, aggregate health data may comprise one or more of the following data types for the plurality of data storage devices: a bit error rate, a number of program/erase cycles, a cross-temperature, or a quality of service time.

In combination with any of the previous examples, a modification of the aspect of memory management may be determined by a model taking aggregate health data as input, the model being configured to determine the modification at least in part based on learned patterns of optimized performance of the plurality of data storage devices, and wherein the instructions, when executed by the one or more processors, cause the one or more processors to retrain the model based on the aggregate health data.

In combination with any of the previous examples, aggregate health data comprising a plurality of health scores respectively may correspond to the plurality of data storage devices or virtual blocks of the plurality of data storage devices, wherein—each of the plurality of health scores is directly proportional to a sum of a first term, a second term, a third term, and a fourth term. The first term may comprise a product of a first coefficient and a bit error rate of a corresponding data storage device, the second term may comprise a product of a second coefficient and a number of program/erase cycles experienced by a corresponding data storage device, the third term may comprise a product of a third coefficient and a cross-temperature experienced by a corresponding data storage device, and the fourth term may comprise a product of a fourth coefficient and a quality of service time for a corresponding data storage device.

In combination with any of the previous examples, each of first, second, third, and fourth coefficients may be: (i) pre-defined, or (ii) determined dynamically during operation of the plurality of data storage devices.

In combination with any of the previous examples, aggregate health data may comprise a plurality of health scores respectively corresponding to the plurality of data storage devices or virtual blocks of the plurality of data storage devices, and a determination to modify an aspect of memory management may be based on determining adequacy of at least one of the plurality of health scores.

In combination with any of the previous examples, an aspect of memory management may be modified via the operational change, a modification to a responsibility assignment, or a combination thereof, and may change the manner in which data is (i) stored on, (ii) transferred to, and/or (iii) transferred from, a plurality of data storage devices or virtual blocks included therein.

In combination with any of the previous examples, an operational change may be enacted at the level of or addressed relative to: (i) a block, (ii) a virtual block, and/or (iii) an address included in at least one of a plurality of data storage devices.

In combination with any of the previous examples, a system for monitoring the health of a plurality of data storage devices may include a computing device communicatively coupled to each of the plurality of data storage devices, one or more processors, and computer-readable media having instructions embodied thereon. The instructions, when executed by the one or more processors, may cause the one or more processors to aggregate health data of the plurality of data storage devices and modify, based on the aggregate health data, an aspect of memory management. Modification to the aspect of memory management may occur via one or both of: enacting an operational change at least one of the plurality of data storage devices, or making a responsibility assignment modification for one or more of the operations among the plurality of data storage devices.

According to various examples of the present disclosure, non-transitory computer-readable media having instructions stored thereon are provided which, when executed by one or more processors, cause the one or more processors to perform the steps comprising the computer-implemented method described above.

### General Considerations

In this description, references to “one embodiment”, “an embodiment”, “embodiments”, “an example”, “one example”, or “examples” mean that the feature or features being referred to are included in at least one embodiment or example of the technology. Separate references to “one embodiment”, “an embodiment”, “embodiments”, “an example”, “one example”, or “examples” in this description do not necessarily refer to the same embodiment or example and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein, unless otherwise expressly stated and/or readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a data storage device to which it is communicatively coupled. A further computer hardware component may then, at a later time, access the data storage device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventors.

What is claimed is:

1. Non-transitory computer-readable media having instructions embodied thereon which, when executed by one or more processors, cause the one or more processors to:
aggregate health data of a plurality of data storage devices; and
modify, based on the aggregate health data, an aspect of memory management by one or both of: enacting an operational change on at least one of the plurality of data storage devices, or making a responsibility assignment modification for one or more operations among the plurality of data storage devices.

2. The non-transitory computer-readable media of claim 1, wherein the aggregate health data is aggregated in real-time during the operation of the plurality of data storage devices.

3. The non-transitory computer-readable media of claim 1, wherein the aggregate health data comprises one or more of the following data types for the plurality of data storage devices: a bit error rate, a number of program/erase cycles, a cross-temperature, or a quality of service time.

4. The non-transitory computer-readable media of claim 1, wherein the modification of the aspect of memory management is determined by a model taking the aggregate health data as input, the model being configured to determine the modification at least in part based on learned patterns of optimized performance of the plurality of data storage devices, and wherein the instructions, when executed by the one or more processors, cause the one or more processors to retrain the model based on the aggregate health data.

5. The non-transitory computer-readable media of claim 1, wherein the aggregate health data comprise a plurality of health scores respectively corresponding to the plurality of data storage devices or virtual blocks of the plurality of data storage devices, wherein—
each of the plurality of health scores is directly proportional to a sum of a first term, a second term, a third term, and a fourth term,
the first term comprises a product of a first coefficient and a bit error rate of the corresponding data storage device,
the second term comprises a product of a second coefficient and a number of program/erase cycles experienced by the corresponding data storage device,
the third term comprises a product of a third coefficient and a cross-temperature experienced by the corresponding data storage device, and
the fourth term comprises a product of a fourth coefficient and a quality of service time for the corresponding data storage device.

6. The non-transitory computer-readable media of claim 5, wherein each of the first, second, third, and fourth coefficients is: (i) pre-defined, or (ii) determined dynamically during operation of the plurality of data storage devices.

7. The computer-readable media of claim 1, wherein the aggregate health data comprise a plurality of health scores respectively corresponding to the plurality of data storage devices or virtual blocks of the plurality of data storage devices, and the determination to modify the aspect of memory management is based on determining adequacy of at least one of the plurality of health scores.

8. The non-transitory computer-readable media of claim 1, wherein the aspect of memory management modified via the operational change, the modification to the responsibility assignment, or a combination thereof change the manner in which data is (i) stored on, (ii) transferred to, and/or (iii) transferred from, the plurality of data storage devices or the virtual blocks included therein.

9. The non-transitory computer-readable media of claim 8, wherein the operational change is enacted at the level of or addressed relative to: (i) a block, (ii) a virtual block, and/or (iii) an address included in the at least one of the plurality of data storage devices.

10. A system for monitoring the health of a plurality of data storage devices, the system comprising:
a computing device communicatively coupled to each of the plurality of data storage devices;
one or more processors; and
computer-readable media having instructions embodied thereon which, when executed by the one or more processors, causes the one or more processors to:
aggregate health data of the plurality of data storage devices; and
modify, based on the aggregate health data, an aspect of memory management by one or both of: enacting an operational change on at least one of the plurality of data storage devices, or making a responsibility assignment modification for one or more of the operations among the plurality of data storage devices.

11. The system of claim 10, wherein the aggregate health data is aggregated in real-time during the operation of the plurality of data storage devices.

12. The system of claim 10, wherein the aggregate health data comprises one or more of the following data types for the plurality of data storage devices: a bit error rate, a number of program/erase cycles, a cross-temperature, or a quality of service time.

13. The system of claim 10, wherein the modification of the aspect of memory management is determined by a model taking the aggregate health data as input, the model being configured to determine the modification at least in part based on learned patterns of optimized performance of the plurality of data storage devices, and wherein the instructions, when executed by the one or more processors, cause the one or more processors to retrain the model based on the aggregate health data.

14. The system of claim 10, wherein the aggregate health data comprise a plurality of health scores respectively corresponding to the plurality of data storage devices or virtual blocks of the plurality of data storage devices, wherein—
each of the plurality of health scores is directly proportional to a sum of a first term, a second term, a third term, and a fourth term,
the first term comprises a product of a first coefficient and a bit error rate of the corresponding data storage device,
the second term comprises a product of a second coefficient and a number of program/erase cycles experienced by the corresponding data storage device,
the third term comprises a product of a third coefficient and a cross-temperature experienced by the corresponding data storage device, and
the fourth term comprises a product of a fourth coefficient and a quality of service time for the corresponding data storage device.

15. The system of claim 14, wherein each of the first, second, third, and fourth coefficients is: (i) pre-defined, or (ii) determined dynamically during operation of the plurality of data storage devices.

16. The system of claim 10, wherein the aggregate health data comprise a plurality of health scores respectively corresponding to the plurality of data storage devices or virtual blocks of the plurality of data storage devices, and the determination to modify the aspect of memory management is based on determining adequacy of at least one of the plurality of health scores.

17. The system of claim 10, wherein the aspect of memory management modified via the operational change, the modification to the responsibility assignment, or a combination thereof change the manner in which data is (i) stored on, (ii) transferred to, and/or (iii) transferred from, the plurality of data storage devices or the virtual blocks included therein.

18. The system of claim 17, wherein the operational change includes one or more of: tuning up a rate at which data is programmed to or read from the plurality of data storage devices; tuning down a rate at which data is programmed to or read from the plurality of data storage devices; establishing one or more parameters for tuning up or tuning down a rate at which data is programmed to or read from the plurality of data storage devices; or establishing conditions distinguishing between a good and bad block, virtual block, or address included in the plurality of data storage devices, and re-training the model based on the conditions.

19. The system of claim 10, wherein the operational change is enacted at a level of or addressed relative to: (i) a block, (ii) a virtual block, and/or (iii) an address included in at least one of the plurality of data storage devices.

20. The system of claim 10, wherein—
the computing device is a host system that includes a controller, and
the operational change is enacted by one or more controller(s) corresponding to the at least one of the plurality of data storage devices.
